(19) United States
(12) Patent Application Publication
(10) Pub. No.: US 2005/0068320 A1
(43) Pub. Date: Mar. 31, 2005

(54) Method for creating and manipulating graphic charts using graphic control devices

(76) Inventor: Denny Jaeger, Oakland, CA (US)

Correspondence Address: Harris Zimmerman;Law Offices of Harris Zimmerman, Suite 710, 1330 Broadway, Oakland, CA, 94612-2506, US

(21) Appl. No.: 10/671,952

(22) Filed: Sep. 26, 2003

(51) Int. Cl. G06T 11/20

(52) U.S. Cl. 345/440

(57) ABSTRACT

A method for creating and manipulating graphic charts, e.g., pie and bar charts, uses associated graphic control devices to provide numeric values for chart components of the graphic charts. The graphic control devices can be any devices having a numeric setting that can be changed, such as faders, dials, knobs, levers, switches, joysticks and buttons. These graphic control devices are operatively connected to the chart components such that changes in the numeric settings of the graphic control devices change the sizes of the chart components accordingly. One or more graphic control devices can be associated with multiple graphic charts to collectively control chart components of these graphic charts.

### FIELD OF THE INVENTION

The invention relates generally to computer programs, and more particularly to a graphic user interface and method for printing graphic elements displayed on a display device.

### BACKGROUND OF THE INVENTION

Graphic charts such as pie charts and bar charts are means to visually present categorical numeric values so that ratios and other relationships between them can easily be determined. Pie charts and bar charts are typically generated using computer spreadsheet programs in the following manner. Categorical numeric values and corresponding labels are entered into an electronic spreadsheet of a computer spreadsheet program. One or more entries in a menu are then selected to activate the chart generating feature of the program. When activated, the computer spreadsheet program displays graphical representations of the categorical numeric values in the form of pie segments or bars to create a pie or bar chart.

The generated graphic chart can then be modified by changing the information contained in the spreadsheet. As an example, a new categorical numeric value and a corresponding label can be added to the spreadsheet to insert an additional pie segment or bar in the chart. As another example, one or more categorical numeric values in the spreadsheet can be altered to change the size of the corresponding pie segments or bars.

A concern with the conventional computer spreadsheet programs is that a user must always refer back to the spreadsheet to modify the categorical numeric values or the categorical labels that are visually represented in the graphic chart. Thus, if numerous categorical numeric values and/or categorical labels are being modified, the user may have to switch back and forth repeatedly between the spreadsheet and the corresponding chart. In addition, manipulating various aspects of the graphic chart may involve navigating through a maze of menu entries in the computer programs to select the appropriate menu entries.

An additional concern is the creation of multiple pie charts or bar graphs that have one or more of their individual elements (e.g., individual pie segments and/or bars) referencing or representing the same piece of numeric information. With spread sheets, this requires causing multiple spread sheets to co-reference each other and being represented in changes to multiple pie or bar charts being controlled by the numeric data contained in these linked spread sheets.

In view of these concerns, what is needed is a method for creating and manipulating graphic charts, such as pie or bar charts, that allows a user to more easily create and modify the categorical numeric values and/or categorical labels of the generated graphic charts and to more easily manipulate various aspects of the generated graphic charts.

### SUMMARY OF THE INVENTION

A method for creating and manipulating graphic charts, e.g., pie and bar charts, uses associated graphic control devices to provide numeric values for chart components of the graphic charts. The graphic control devices can be any devices having a numeric setting that can be changed, such as faders, dials, knobs, levers, switches, joysticks and buttons. These graphic control devices are operatively connected to the chart components such that changes in the numeric settings of the graphic control devices change the sizes of the chart components accordingly. One or more graphic control devices can be associated with multiple graphic charts to collectively control chart components of these graphic charts.

A method in accordance with an embodiment of the invention includes providing graphic control devices that are controllable by a user to change numeric values of the devices, selectively associating the graphic control devices to a graphic chart to be created so that the numeric values of the graphic control devices correspond to chart components of the graphic chart, and displaying the chart components to create the graphic chart. The displayed chart components visually represent the numeric values of the graphic control devices.

An embodiment of the invention includes a storage medium, readable by a computer, tangibly embodying a program of instructions executable by the computer to perform method steps for creating and manipulating graphic charts.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 shows the programming of a fader by dragging numeric and text characters to overlap the fader.

FIG. 2 illustrates the changing of the Fader Scale Factor and Decimal place in the Info Canvas object for the Blackspace canvas. The terms “Info Canvas” and “Blackspace” are trademarks of NBOR Corporation.

FIG. 3 depicts the creation of a pie chart by the drawing of a control arrow and a modifier arrow.

FIG. 4 shows a chart key for a pie chart.

FIG. 5 depicts updating a chart key to show a change in the value of a fader that controls one of the segments of a pie chart.

FIG. 6 shows the creation of two pie charts and adding same two faders to each of the pie charts.

FIG. 7a shows the two pie charts of FIG. 6 with their respective chart keys visible onscreen.

FIG. 7b depicts a change in a fader value and the effect of this change on the segments of the two pie charts and on the pie chart keys.

FIG. 8 is flowchart of a process for creating a pie chart.

FIG. 9 is flowchart of a process for creating a pie chart control.

FIG. 10 depicts a cross hatched pie chart resulting from the deletion of all fader controls which had been controlling its segments.

FIG. 11 is a flowchart of a process for changing the color of a chart element.

FIG. 12 is a flowchart of a process for deleting a device that is controlling an element in a graphic chart.

FIG. 13 is flowchart of a process for adding an item to the chart model.

FIG. 14 is flowchart of a process for responding to a change in a fader value.

FIG. 15 illustrates a vertical bar chart that has been created using a method in accordance with an embodiment of the invention.

FIG. 16 illustrates the vertical bar chart of FIG. 15 that has been converted to a horizontal bar chart.

FIG. 17 is a diagram of a computer system in which a method for creating and manipulating graphic charts in accordance with an embodiment of the invention has been implemented.

FIG. 18 is a flow diagram of a method for creating and manipulation graphic charts in accordance with an embodiment of the invention.

### DETAILED DESCRIPTION

A method for creating and manipulating graphic charts in accordance with an exemplary embodiment of the invention utilizes graphic control devices to create and manipulate the graphic charts. In contrast to conventional methods in which electronic spreadsheets are used to input categorical numeric values for graphic charts, the method allows a user to select one or more graphic control devices to input the categorical numeric values for the graphic charts. The numeric settings of these selected graphic control devices are associated with the categorical numeric values used to generate the graphic charts. Consequently, the graphic control device can be used change the categorical numeric values. As a result, the corresponding graphic charts are modified according to the changes in categorical numeric values. Therefore, the method eliminates the need for electronic spreadsheets for the creation and manipulation of graphic charts. The graphic control devices may be any type of graphic device that can be controlled by a user to change the numeric setting of the device, such as faders, dials, knobs, levers, switches, joysticks and buttons. As used herein, a graphic chart refers to any chart or graph having graphic components that represent categorical numeric values, such as a pie or bar chart.

As described in more detail below, the method can be used to create independent graphic charts, e.g., pie and bar charts, in which graphic components, e.g., pie segments and bars, of the charts can be individually controlled by graphic control devices that are associated with the graphic components. The method can also be used to create co-dependent graphic charts in which common graphic components of different charts can be controlled by a single graphic control device. In the exemplary embodiment, the method is implemented as a computer program and will sometimes be referred herein as such.

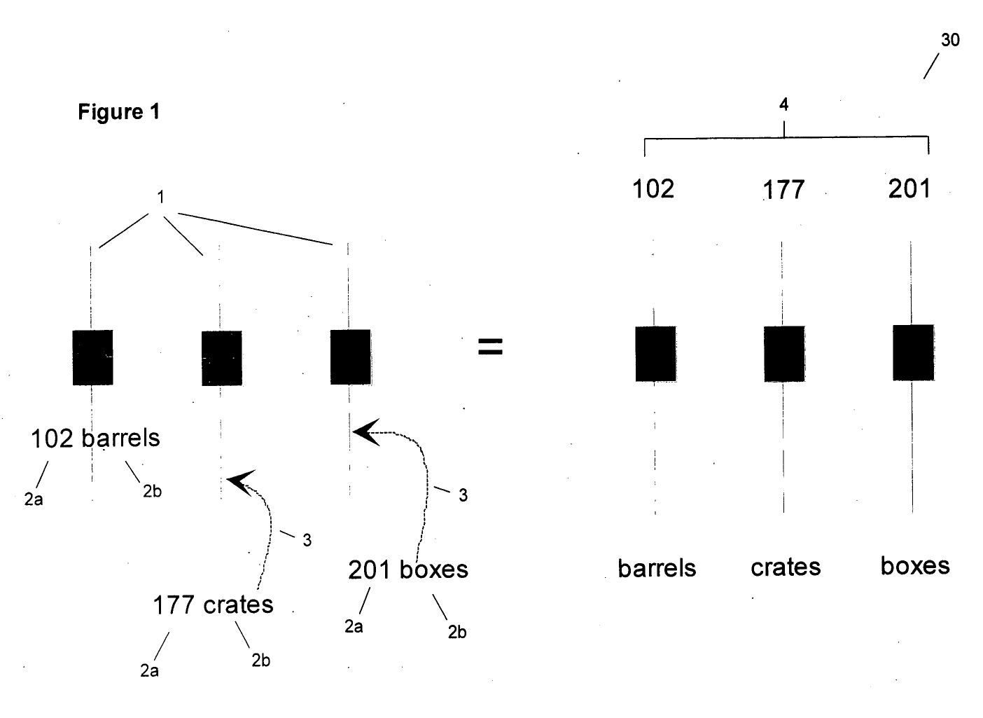

Turning now to FIG. 1, the first step in creating a pie chart using the method in accordance with the exemplary embodiment of the invention is illustrated. Three graphic control devices in the form of faders 1 are created in a computer operating environment referred to herein as “Blackspace” environment. The word “Blackspace” is a trademark of the NBOR Corporation. Blackspace environment presents one universal drawing surface that is shared by all graphic objects within the environment. Blackspace environment is analogous to a giant drawing “canvas” on which all graphic objects generated in the environment exist and can be applied. Each of these graphic objects can have a user-created relationship to any or all the other objects. There are no barriers between any of the objects that are created for or exist on this canvas. However, the invention is not limited to the Blackspace environment and can be implemented in any computer operating environment.

These faders 1 can be created using various means, including the following: drawing the faders in a manner that is recognized in the computer operating environment, selecting “fader” in a menu, using a verbal command, printing the characters “f a d e r” onscreen. Next, three groups of characters are entered into the computer operating environment. As an example, the characters can be typed or verbally inputted into the computer operating environment. These groups of characters may include two parts, a numeric portion 2a and a text portion 2b. The order of these portions in the groups of characters does not matter. For the purposes of this illustration, the numeric portion 2a will be first and text portion 2B portion will be second.

These groups of characters may be entered anywhere onscreen using any of the above-described methods. Once on the screen, the groups of characters are then dragged to the different faders 1 such that each group of characters intersects any part of the respective fader or fall within a defined gap distance to that fader to program the faders using the information contained in the characters. As an example, the “177 crates” characters are dragged along the line 3 to the middle fader 1 by clicking on the right mouse button when the cursor is on the “177 crates” characters and then moving the cursor to the middle fader to drag the “177 crates” characters to overlap the middle fader. When the right mouse button is then released, the “177 crates” characters automatically programs the middle fader 1. Similarly, the “201 boxes” can be dragged to the right fader 1 to program that fader. However, if a group of characters intersects a fader when entered onscreen, such as the “102 barrels” characters, then the group of characters automatically programs the intersected fader as soon as the characters are entered. Thus, in this case, the group of characters does not have to be dragged to a fader.

The programming of a fader with a group of characters has at least two parts: (1) the numeric portion of the characters sets the scaling for the fader and the current value (“numeric setting”) for the fader, and (2) the text portion of the characters becomes the label for that fader.

Also upon the mouse up-click or release, the group of characters is automatically broken into two parts and these two parts are automatically displayed at locations adjacent to the intersected fader. As an example, the numeric part of the characters is automatically displayed at the top of the intersected fader and the text part of the characters is automatically displayed at the bottom of the fader, as illustrated by the faders 4 in FIG. 1. These automatic locations of the numeric and text parts are purely arbitrary and can be changed to any locations on the Blackspace drawing surface or canvas 30 that the user chooses by making appropriate selections in a menu. Alternatively, the displayed locations of the numeric and text parts may be changed by physically dragging the numeric and text parts to new locations after performing the mouse up-click.

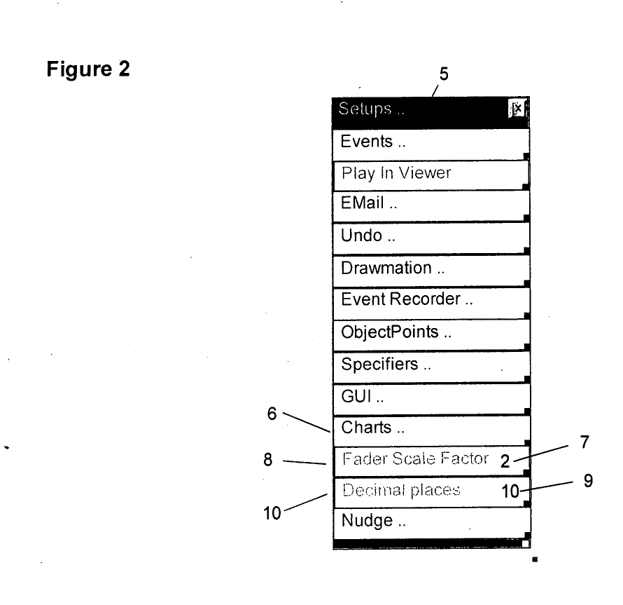

The scaling factor for the faders and the number of decimal places for the numeric values of the faders can defined by the user, for example, using the Info Canvas object 5 for the Blackspace canvas, as illustrated in FIG. 2. The term “Info Canvas” is a trademark of NBOR Corporation. The Info Canvas object 5 for the Blackspace canvas provides entries to change the properties of various elements in the Blackspace environment or control functions associated with those elements. Thus, the Info Canvas object 5 serves as a menu for using various elements in the Blackspace environment. For more information about Info Canvas objects, see simultaneously filed U.S. patent application Ser. No. ______, entitled “Intuitive Graphic User Interface with Universal Tools”, which is incorporated herein by reference.

The scaling factor for the faders can be defined by the user in the following manner. First, the Info Canvas object 5 for the Blackspace canvas is made to appear onscreen by right clicking on the mouse or its equivalent when the cursor is on the Blackspace canvas. In this Info Canvas object 5 under the heading “Charts” 6, the user places a text cursor next to or on top of the numeric value 7 for the entry “Fader Scale Factor” 8. Then the user enters a modified numeric value for this scale factor by typing or verbally entering the numeric value. Shown in FIG. 2 is a scale factor of two, as indicated by the numeric value “2” in the entry “Fader Scale Factor” 8. This scale factor is the amount that the numeric setting of a fader will be multiplied by to create a total scale value for that fader.

As an example, in FIG. 1, the numeric setting for the fader with the label “barrels” is “102”. With a scale factor of two, the maximum setting for this fader will be a numeric value of “204”. Thus, this fader will be placed half way between the maximum position (top) and the minimum position (bottom) of the fader, assuming that the fader operates linearly, which is the case for this example. In the exemplary embodiment, the default setting for a fader is linear scaling, which can be changed by a user in a simple menu where the user selects the type of scaling, e.g., linear, logarithmic, etc.

The number of decimal places for the faders can be defined by the user in the following manner. In the Info Canvas object 5 under the heading “Charts” 6, the user places a text cursor next to or on top of the numeric value 9 for the entry “Decimal places” 10. Then the user enters a modified numeric value for this parameter by typing or verbally entering the numeric value. If the number zero (“0”) is entered, then each numeric value of the faders will be a whole number with no decimal places. If the number fifteen (“15”) is entered, then each fader will show an accuracy of fifteen decimal points and so on.

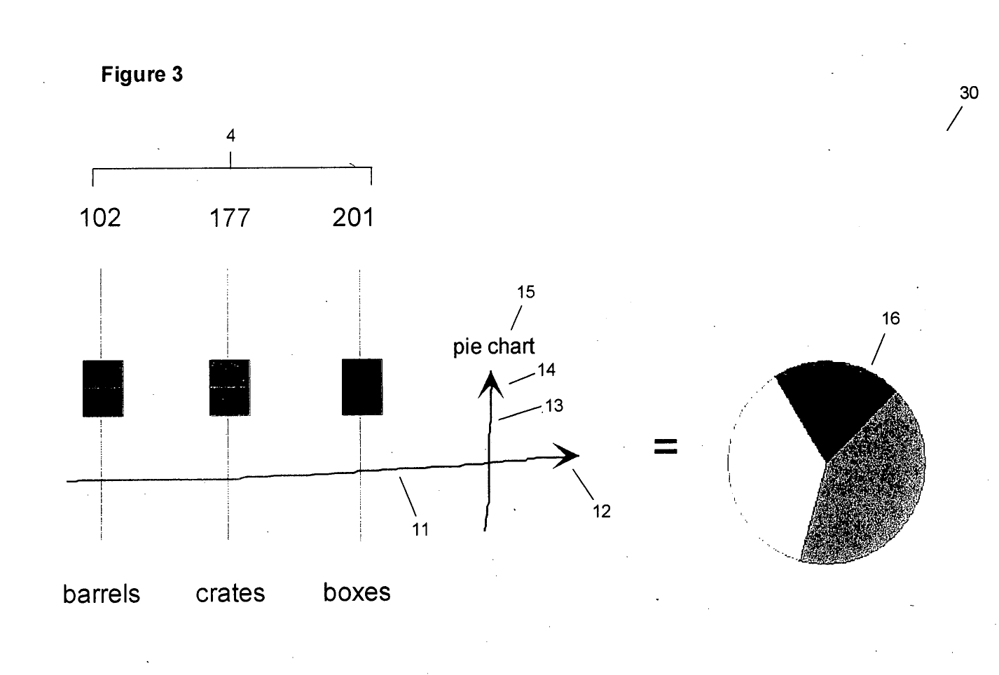

The next step in the creation of a pie chart using the method in accordance with the exemplary embodiment of the invention is the selection of the faders to control a graphic component of a graphic chart to be generated, as illustrated in FIG. 3. After programming the faders 4, a user draws a special arrow, e.g., a red arrow 11, which has a “control” arrow logic assigned it, that selectively encircles or intersects the faders to select the faders to be used to create a pie chart. Although in FIG. 3 all three faders 4 are selected, the user may select any number of displayed faders to create a pie chart having a corresponding number of pie segments. The head 12 of the arrow 11 is drawn to point to the Blackspace canvas 30. The “control” arrow logic has the following logic: “the items from which the arrow is drawn control the item to which the arrow points to.” For more information on arrow logic, see pending U.S. patent application Ser. No. 09/880,397, filed on Jun. 12, 2001, entitled “Arrow Logic System for Creating and Operating Control Systems”, which is incorporated herein by reference.

The “control” arrow logic is then modified to associate the faders 4 to a graphic chart. In the exemplary embodiment, the “control” arrow logic is modified by drawing a second arrow 13, which is referred to as a modifier arrow, to intersect the first arrow 11. As an example, the second (modifier) arrow 13 may be drawn such that the shaft of the second arrow crosses the shaft of the first (red) arrow 11, as shown in FIG. 3. As another example, the second arrow 13 may be drawn such that the head 14 of the second arrow points to the shaft of the first arrow 11 or emanates from the shaft of the first arrow.

When the modifier arrow 13 is recognized by the computer program, a text cursor (not shown) automatically appears adjacent to the tip of its arrowhead 14. The user then types a name for the desired action. If the desired action is the creation of a pie chart, the name “pie chart” 15 (or its equivalent) is entered, as shown in FIG. 3. When this action name is entered, the computer program indicates the recognition of a valid arrow logic by, for example, changing the color of one or both arrowheads 12 and 14 to white (not shown). However, the recognition of a valid arrow logic could be presented in other manners. As an example, one or both of the arrowheads could start flashing and remain the same color as the shaft of the respective arrow. As another example, one of both of the arrowheads 12 and 14 could become larger and smaller in a pulsating motion.

After the arrow logic is recognized, the arrow logic is activated to cause the desired action by, for example, touching either arrowhead 12 or 14. As an example, one of the arrowheads 12 and 14 could be “touched” by left-clicking the mouse the arrowhead, by touching the arrowhead using a finger or a stylus (assuming a touch sensitive screen), making a verbal command or entering any equivalent command. Upon the touching of either white arrowhead 12 or 14, the computer program removes the arrows 11 and 13 and builds a pie chart 16 using the parameters, i.e., the numeric settings and the corresponding labels, that have been entered for each of the faders 4 intersected by the arrow 11, as shown in FIG. 3. After the pie chart 16 appears onscreen, the user can reposition the chart to any location onscreen by clicking on the chart and dragging it using a mouse or by any equivalent means.

After the creation of the pie chart 16, the computer program permits the user to modify the pie chart while continually viewing the pie chart. Thus, various relative percentages of the categorical numeric values represented by the pie chart segments of the pie chart can be viewed as one or more of these percentages are increased and/or decreased by changing the numeric settings of the corresponding faders 4, as described in more detail below. In addition, the user can continually view the numeric setting of each fader 4 as one or more of the numeric settings are changed by moving the respective faders.

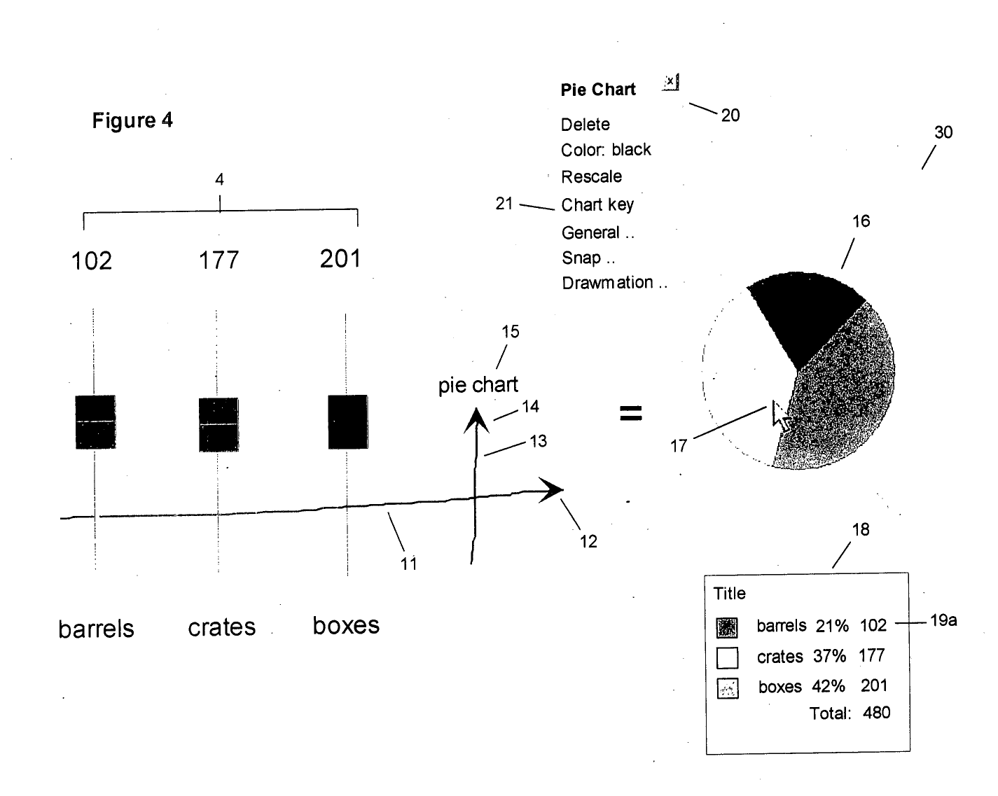

For each pie chart, a pie chart key for that pie chart can be made to appear onscreen. FIG. 4 shows the pie chart key 18 for the pie chart 16. A user can obtain this key at any time by selecting the entry “Chart key” 21 in the Info Canvas object 20 for the pie chart 16. The Info Canvas object 20 can be made to appear onscreen by right-clicking on the pie chart 16 with a mouse cursor 17. Upon selecting the entry “Chart key” 21, the chart key 18 will appear onscreen. This chart key 18 consists of multiple rows and columns. Each row corresponds to a pie segment for the pie chart 16. One of the columns contains colored rectangles that match the colors of the pie segments of the pie chart 16. Although not illustrated in FIG. 4, the labels of the faders 4 may be in colors that match the colors of the corresponding rectangles in the chart key 18 and the colors of the corresponding pie segments of the pie chart 16. Thus, color is an essential part of the pie chart key 18. Another column includes the title of each pie segment, e.g., barrels, crates and boxes. Another column includes the relative percentages of the pie segments with respect to the entire pie. Finally, the last column includes the numeric values of the pie segments in the pie chart 16 that equal the numeric settings of the faders 4. Thus, for each pie segment or category, the color of the corresponding pie segment in the pie chart 16, the corresponding label, the corresponding relative percentage and the corresponding numeric value can be readily determined by the chart key 18.

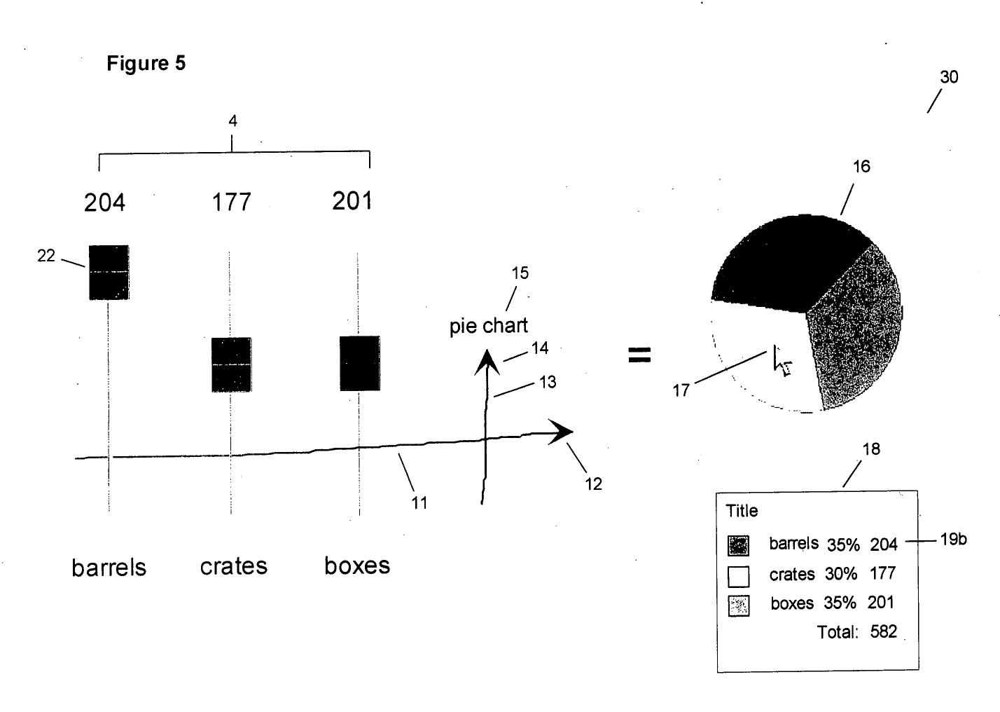

The pie segments of the pie chart 16 can be modified by changing the numeric setting of one or more of the faders 4. An example of this process is illustrated in FIG. 5. When one of the faders 4, e.g., the fader 22, is moved to change the numeric setting or value of that fader to “204” from “102”, the corresponding numeric value in the pie chart key 18 is also changed to “204” 19b, as shown in FIG. 5, from “102” 19a, as shown in FIG. 4. In response, the computer program recalculates the percentages for all of the segments in the pie chart 16 accordingly. This in turn changes the respective sizes of the individual pie segment in the pie chart 16 and all the percentages in the pie chart key 18. The percentages in the pie chart key 18 change from 21% to 35% for the categorical label “barrels”, from 37% to 30% for the categorical label “crates” and from 42% to 35% for the categorical label “boxes. These changes occur in real time. Thus, a user can quickly change any value that is being represented in the pie chart 16 and immediately see the change in the percentages in the pie chart key and in the sizes of the pie chart segments.

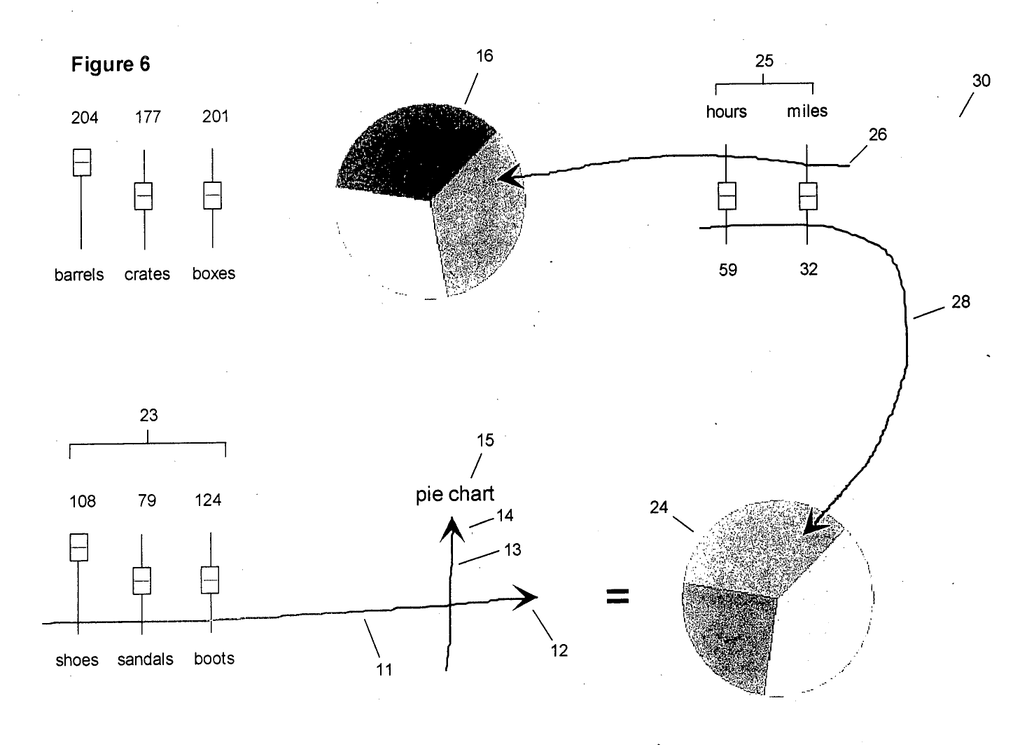

Multiple pie charts can be created that interact with each other using the computer program. Referring to FIG. 6, three more faders 23 have been created and labeled respectively as “108 shoes”, “79 sandals”, and “124 boots”. Then a red control arrow 11 has been drawn to intersect these three faders 23 with the arrowhead 12 pointing to the Blackspace drawing surface 30. A modifier arrow 13 has then been drawn to intersect the red control arrow 11 and the text “pie chart” 15 has been typed at the end of the arrowhead 14 of the modifier arrow 13. Then one of the arrowheads 12 and 14 is selected, which results in the creation of a second pie chart 24.

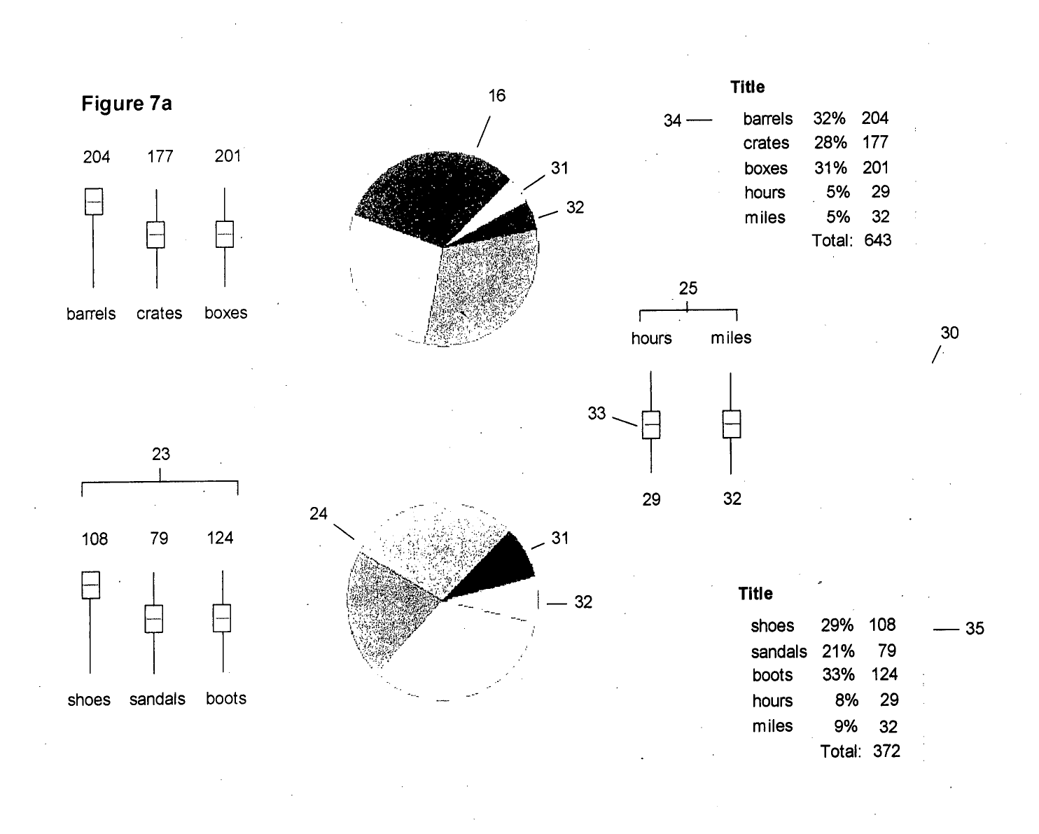

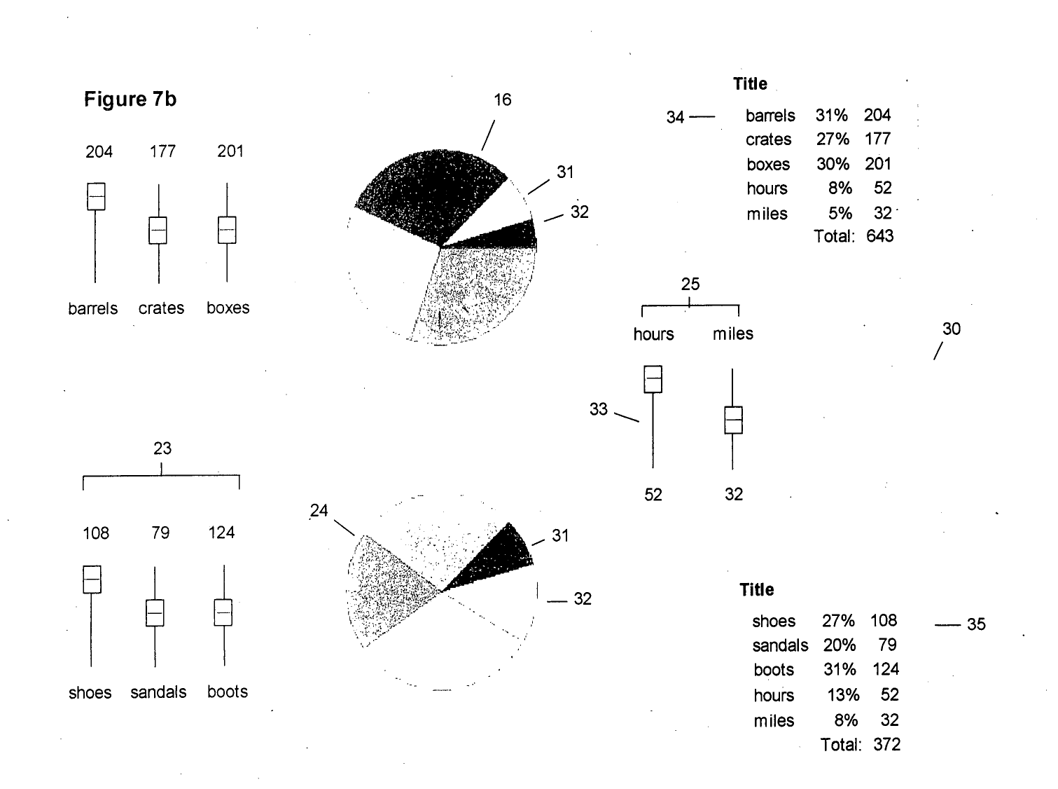

Then two more faders 25 are created and a red control arrow 26 is drawn to intersect these two faders and made to point to the first pie chart 16. Another red control arrow 28 is also drawn to intersect the two faders 25 and made to point to the second pie chart 24. Then the arrowheads for the red control arrows 26 and 28 are selected, which causes two more segments 31 and 32 to be added to each of the two pie charts 16 and 24, as shown in FIG. 7a.

Also shown in FIG. 7a are two pie chart keys 34 and 35. The pie chart key 34 is the key for the pie chart 16 and the pie chart key 35 is the key for the pie chart 24. In both chart keys, new entries for the categories “hours” and “miles” have been added. The numeric values for the categories “hours” and “miles”, which are “29” and “32”, respectively, are the same in both keys. However, the percentages for these numeric values are different in each key, as well as the sizes of the corresponding pie chart segments in the pie charts 16 and 24. The computer program automatically recalculates the relative percentages of each added pie chart segment as it relates to each separate pie chart 16 and 24.

Referring to FIG. 7b, one of the faders 25, e.g., the fader 33, has been changed to increase the numeric value of hours to “52” from “29”. This new value is immediately reflected in both of the pie charts 16 and 24 and in the associated chart keys 34 and 35, respectively. In addition, the change of this single fader 33 automatically changes the ratios of every pie chart segment in both pie charts 16 and 24 to each of the other pie chart segments in the respective pie chart. This approach can be used to create very complex ratios and have these ratios immediately represented in three ways:
(1) Graphically, as in pie chart segments as shown in the pie charts 16 and 24 or in bars in a bar graph (discussed below).
(2) As numbers, e.g., “52” hours as compared to “102” boxes for the pie chart 16 or “52” hours compared to “79” sandals in the pie chart 24.
(3) As percentages, e.g., “52” hours represents 8% of the pie chart 16, but it represents 13% of the pie chart 24.

Various processes for creating and manipulating graphic charts in accordance with an embodiment of the invention are now described with reference to different flowchart. The following are definitions of terms that are used in describing some of these processes.

1. Chart Control.

This is the chart which appears on the screen. This chart can be of various types, e.g., a pie chart, bar graph and their equivalents. A chart control is the graphical item being displayed. The words “chart control” are synonymous with the word “chart.”

2. Chart Key Control

This means the chart key all of its contents. A chart key is a VDACC object or its equivalent, e.g., a menu, that lists various elements of a chart and various aspects of these elements. For more information about VDACC objects, see simultaneously filed U.S. patent application Ser. No. ______, entitled “Intuitive Graphic User Interface with Universal Tools”. Typically a chart key will have four columns defining each chart data item: (a) colored rectangles that equal the color of each pie segment or bar in a chart, (b) the name of each text label assigned to each fader that controls each pie segment or bar in a chart, (c) the percent of the total chart that a specific pie segment or bar represents, and (d) the numeric value which a specific fader that is controlling a pie chart segment or bar in a bar chart is set at.

3. Chart Data Item

A chart data item refers to one of the items of data being displayed by a chart. The chart data item is what is being represented visually by a pie chart segment or a bar on a bar chart. If the data item is changed (i.e. its value is altered due to manipulation of a fader) or deleted, the chart and chart key must be redrawn to reflect this.

4. Chart Model.

The chart data model is a C++ class which manages the chart data items currently being displayed by the chart and chart key. The chart model is used to tell the chart how many chart data items there are, what the minimum and maximum values of all the data items are, and the charts can query the chart data model to find the information (value, name etc.) about individual data items e.g. during the rendering process. When a fader is added to a chart, a new entry in the chart model is created to keep a track of the information for that fader. When a fader is removed from the chart the entry for that fader is removed from the chart model. The chart data items are stored within the chart model in a C++ structure called a list, which allows addition, deletion and retrieval of chart data items.

5. Fader Object.

A fader object is a fader on the screen which has been created by the user drawing a horizontal or vertical line intersected by a “U” shaped line. Another method of creating a fader could using a verbal command, e.g., “create fader.”

6. Value Fader.

A value fader is a fader onto which a piece of text has been dragged, causing the text item to act as a label for that fader and become permanently associated with that fader. If a value fader is connected to a chart, the text of the label of that fader is displayed in the chart key, allowing the user to see which pie segment or bar (depending on the chart type) represents which value fader. The text that can be dragged to a value fader can include both a word or letters and a numeric value (a number) or just one or the other.

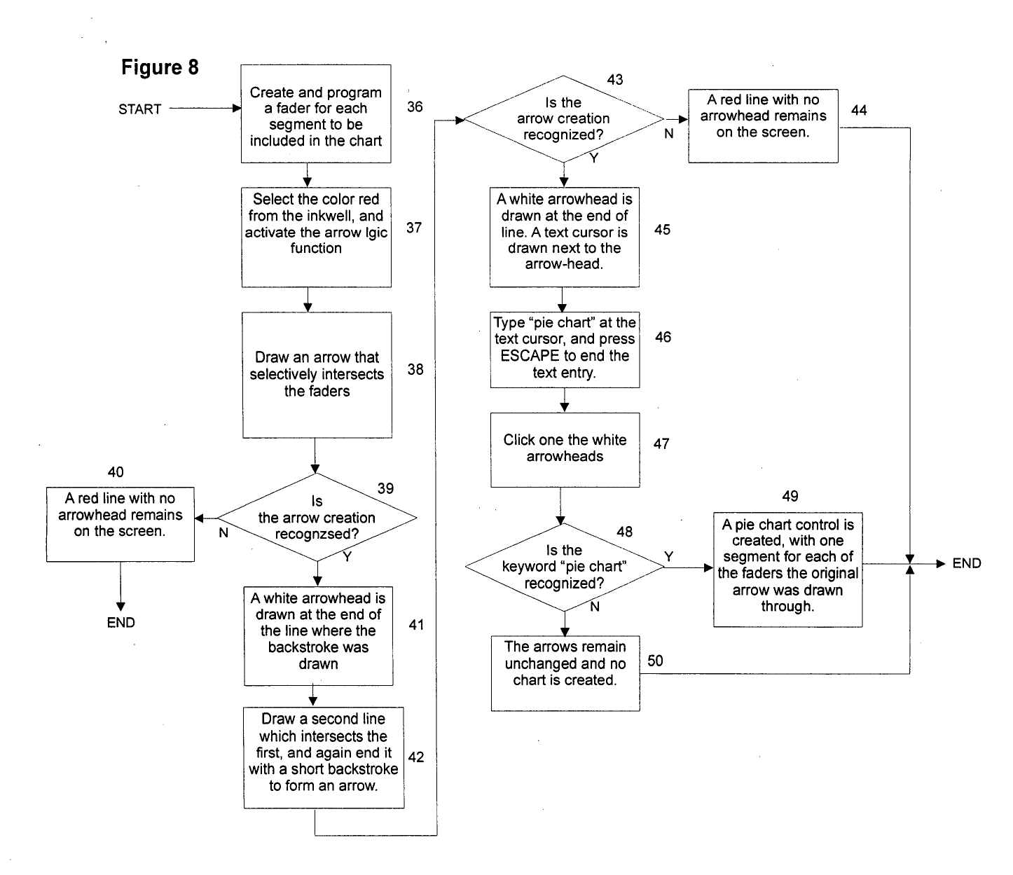

Referring to FIG. 8, a flowchart of a process for creating a pie chart in accordance with an embodiment of the invention is shown. At first step 36, a fader is created and programmed with a label and a numeric setting for each pie chart component or segment to be included in the pie chart. The programming of a fader involves entering a set of characters that includes a numeric setting or value followed by a name for a pie chart element. The characters are then dragged onto the fader to program the fader with the numeric value and the corresponding name. This fader programming process is illustrated in FIG. 1. Next, at step 37, the color red is selected from a free draw inkwell and arrow logic function is activated by, for example, turning on an “arrow” switch. The free draw inkwell can be any type common in the art. An example of such an inkwell is a 24 bit inkwell which would support approximately 16 million colors.

Arrow logics are generally assigned to colors. When a color is selected and the arrow logic function is activated, the selected color automatically activates the arrow logic assigned to that color. In this case, the arrow logic is a “control logic”, which equates to: “The items that the arrow is drawn from (the items that are either intersected, encircled or otherwise selected by the shaft of the arrow) controls the item that the arrow points to.” In the case of creating a pie chart, the items that the arrow is drawn from are faders, knobs, joysticks or some combination of graphic control devices that a user can alter the settings of such devices by some type of user input. The item that the arrow points to is the global drawing surface, a desktop, or any appropriate screen area.

At step 38, a red arrow is drawn that selectively intersects the faders to be used to create the pie chart. The drawing of the red arrow can be achieved by drawing a line that intersects the faders and ending the line with a short backstroke on the global drawing surface, which is recognizable by the computer program as an arrowhead. The “short backstroke” is a convenience in the computer program that enables a user to create an arrowhead by drawing only one half of it.

Next, at step 39, a determination is made whether the arrow creation is recognized. The computer program has the ability to recognize the drawing of an arrow. For more detail about the recognition of a drawn arrow, see pending U.S. patent application Ser. No. 09/880,397, filed on Jun. 12, 2001, entitled “Arrow Logic System for Creating and Operating Control Systems”. If the arrow is not recognized, a red line with no arrowhead remains onscreen and the computer program does not redraw the arrow and its arrowhead as a computer generated graphic, at step 40, and the process comes to an end. If the arrow is recognized, a white arrowhead appears at the end of the drawn line where the backstroke was drawn, at step 41. This white arrowhead appears as the backstroke is completed and an up-click or its equivalent is performed with the mouse or its equivalent.

Next, at step 42, a second (“modifier”) arrow is drawn that intersects the shaft of the first arrow. Again, the drawing of this second arrow may be achieved by drawing a line that intersects the shaft of the first arrow and ending the line with a short backstroke on the global drawing surface. This second arrow still uses the same arrow logic as the previous arrow, and thus the same color remains selected. Note: it would be possible to use any color for this arrow since a modifier arrow is not necessarily dependent upon color and the associated arrow logics. Rather, a modifier arrow is dependent upon the context in which it is drawn. In this case, the context is intersecting a red control arrow such that the modifier intersects one or more devices, which has been programmed with a text and a numeric value, and the red control arrow is pointing to the global drawing surface or a blank space onscreen.

Next, at step 43, a determination is made whether the creation of the modifier arrow is recognized. If no, then a red line with no arrowhead remains on the screen, at step 44, and the process comes to an end. If yes, then a white arrowhead is drawn at the end of the modifier arrow's shaft, at step 45. In addition, a text cursor appears at the end of this white arrowhead. Next, at step 46, a user types the kind of chart that is desired. In this case, the user types “pie chart.” Note: if “bar chart” were typed, then the result would a bar chart, instead of a pie chart. At the conclusion of the typing of “pie chart”, the user activates the Escape key, the Enter key or any equivalent command to enter the text “pie chart” into the computer program.

Next, at step 47, a user touches either of the white arrowheads by any available method. The two choices are the white arrowhead of the originally drawn arrow that intersects the devices or the white arrowhead of the modifier arrow that was drawn to intersect the first drawn arrow.

Next, at step 48, a determination is made whether the keyword “pie chart” is recognized. The computer program has the ability to recognize key words and “pie chart” is one of them. The computer program has an internal list of known keywords, which may be recognized under certain circumstances (i.e. the keywords are context-sensitive). When the user finishes typing, the text that was entered is compared against the list of keywords that are relevant to the current action. If the text matches one of the keywords, then the appropriate action for that keyword is taken. The text-matching process does not take the case of the text into account, i.e. the process is case insensitive. Thus, “PIE CHART”, “Pie Chart” and “pie chart” would all be recognized.

If the keyword “pie chart” is not recognized, then the modifier arrow remains unchanged and no chart is created, at step 50, and the process comes to an end. If the keyword “pie chart” is recognized, a pie chart control or pie chart is created, at step 49. For each device, e.g., for each fader that was intersected by the originally drawn red arrow, a pie chart segment is created. The respective size of each pie chart segment is determined by the numeric value assigned to each fader that was intersected by the drawn red arrow. The computer program automatically generates a ratio or comparison between each of the numeric values for each of the intersected faders and represents these ratios or comparisons as a graphic pie chart.

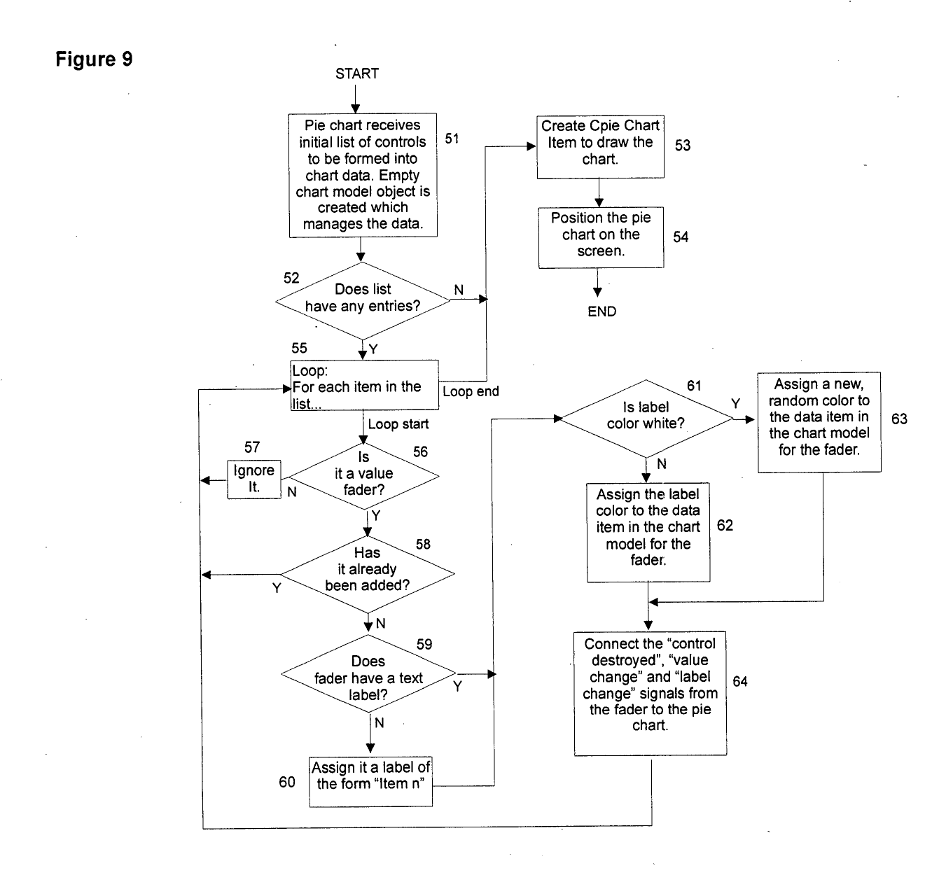

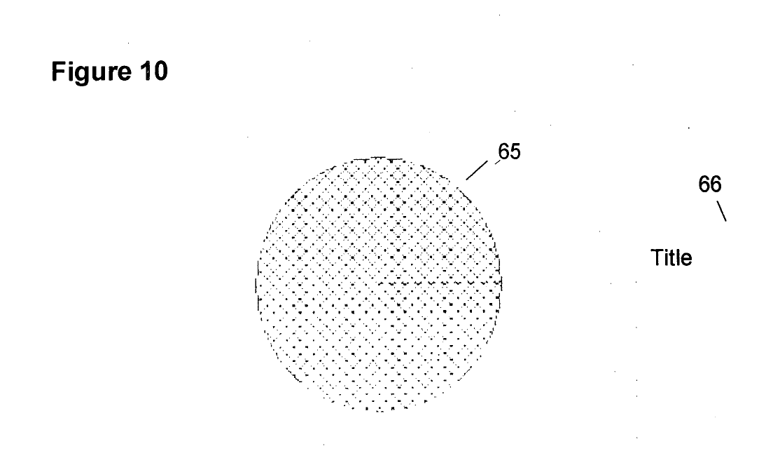

Turning now to FIG. 9, a flowchart of a process for creating a pie chart control is shown. At step 51, the pie chart receives an initial list of controls to be formed into chart data and an empty chart model object that manages the data is created. Next, at step 52, a determination is made whether the list has any entries. A pie chart should always be created with at least one data item. If a chart is created with no items in its list, or all of its items are later deleted from the chart, the chart will be drawn with a red, crosshatched pattern to indicate that no data is currently available, as illustrated in FIG. 10. In this figure, a pie chart 65 has had all of its elements deleted as shown by an empty key 66 for this pie chart. As a result, the pie chart 65 is crosshatched to indicate that it is currently empty. Although a crosshatched pie chart is used in the exemplary embodiment to indicate an empty pie chart, any suitable graphic can be substituted for the cross hatch pie chart to indicate an empty pie chart, e.g., a blank pie chart with no segments, a pie chart with a transparent center, a shaded pie chart, etc.

If a user wished to add one or more elements to this pie chart 65, the user would create one or more faders or some other graphic control devices, such as knobs and/or joysticks, and type at least a text label for those faders. The user would then draw a control arrow from the faders to the pie chart 65 and intersect this arrow with a modifier arrow. Furthermore, the user would type “pie chart” at the tip of the modifier arrow. When either of the arrowheads is then selected, the pie chart 65 will cease to be crosshatched and will show a pie segment for each fader that was intersected by the control arrow. The basic process of drawing arrows to create a pie chart is shown in FIG. 3. The process of adding additional elements to a previously created pie chart is shown in FIG. 6.

Referring again to FIG. 9, if the list does not have any entries, then a chart item, e.g., a Cpie Chart Item, is created to draw the pie chart, at step 53. Next, at step 54, the pie chart is positioned on the screen and the process then comes to an end. The resulting pie chart is a crosshatched pie chart to indicate that the pie chart has no entries. If the list does have one or more entries, then a loop begins at step 55 for each item in the list. The first step in the loop is step 56, where a determination is made whether the item is a value fader, which is a fader that has been programmed by dragging a piece of text and a numeric value to overlap some portion of it. If no, then the item is ignored, at step 57, and the process returns to step 55. The list consists of generic graphic controls. However, only value faders or their equivalents are used, and thus any other control types are ignored. Ideally, the list should contain only value faders or their equivalents but if the list does contain other control types, this will not cause a problem since other control types are ignored. This means that if the user inadvertently included some other control (e.g., a star or text control) when the user was drawing the control arrow through the faders, this control may be added to the list of controls, which are then passed to the pie chart creation code. The pie chart code does not assume that all the controls presented are faders or similar function devices, e.g., a knob or joystick, but first checks the controls and ignores any that are not such devices. This is a safety check to ensure that the pie chart is only created from valid types of controls.

If the item is not a value fader, then another determination is made whether the item has already been added, at step 58. This test prevents the same fader from being accidentally added twice to the same pie chart, which would be invalid. If yes, then the process returns to step 55. If no, then a determination is made whether the fader has a text label, at step 59. This is an optional check in the computer program. The text label refers to the piece of text that a user drags to a fader to label the fader. If the fader does not have a text label, then the fader is assigned a label of the form “Item n”, where n is an integer, at step 60. This is another safety check. If, for some reason, the faders do not have labels (such as “apples”, “oranges”, “pears”), the computer program will give labels to them, starting with “Item 1”, then “Item 2” for the next non-labeled fader, and so on.

If the fader does have a text label, then a determination is made whether the label color is white, at step 61. If yes, then a random color is assigned to the pie chart segment that is controlled by the fader or an equivalent device, at step 63. If no, then the label color of the fader is assigned to the data item in the chart model for that fader, at step 62. In other words, the pie segment that is controlled by this fader has the same color as the label for that fader. That is, if the fader has been assigned a color, the associated pie segment will be given that color. For example, if the label text on the fader is blue, then the pie segment for that fader will also be blue. If the fader label has the default color of white, then a random color is generated and assigned to the pie segment. When the chart model is given a new color for a particular segment, the chart model will also pass that color on to the associated fader label. Thus, the automatically generated colors of the pie segments are reflected in the original fader. For example, if a fader with a white label is added to the pie chart, the pie chart will create a new color, e.g., green, and both the pie segment and the fader label will become green.

Next, at step 64, the “control destroyed”, “value change” and “label change” signals from the fader are connected to the pie chart. These signals are used for the following purposes:
A. Control destroyed signal—indicates to the pie chart that a particular fader has been destroyed (i.e., deleted). It will be removed from the chart model and the associated pie segment will be deleted. Thus, if a fader that is attached to a pie chart is deleted, the chart will be updated to reflect the removal of the fader.
B. Value change signal—indicates to the pie chart that the value of an attached fader has changed. The chart model, the pie segment sizes and the chart key are recalculated and redisplayed to show the new value.
C. Label change signal—indicates that the label text or color of a particular attached fader has been altered. The chart model and display are again recalculated and updated to show this change.

At this point, the loop for this device is concluded and the process then proceeds back to step 55. If there is another device (item) in the list, the loop starts again for this device. The loop is repeated until all of the devices in the list have been processed. The process then performs the steps 53 and 54, and comes to an end.

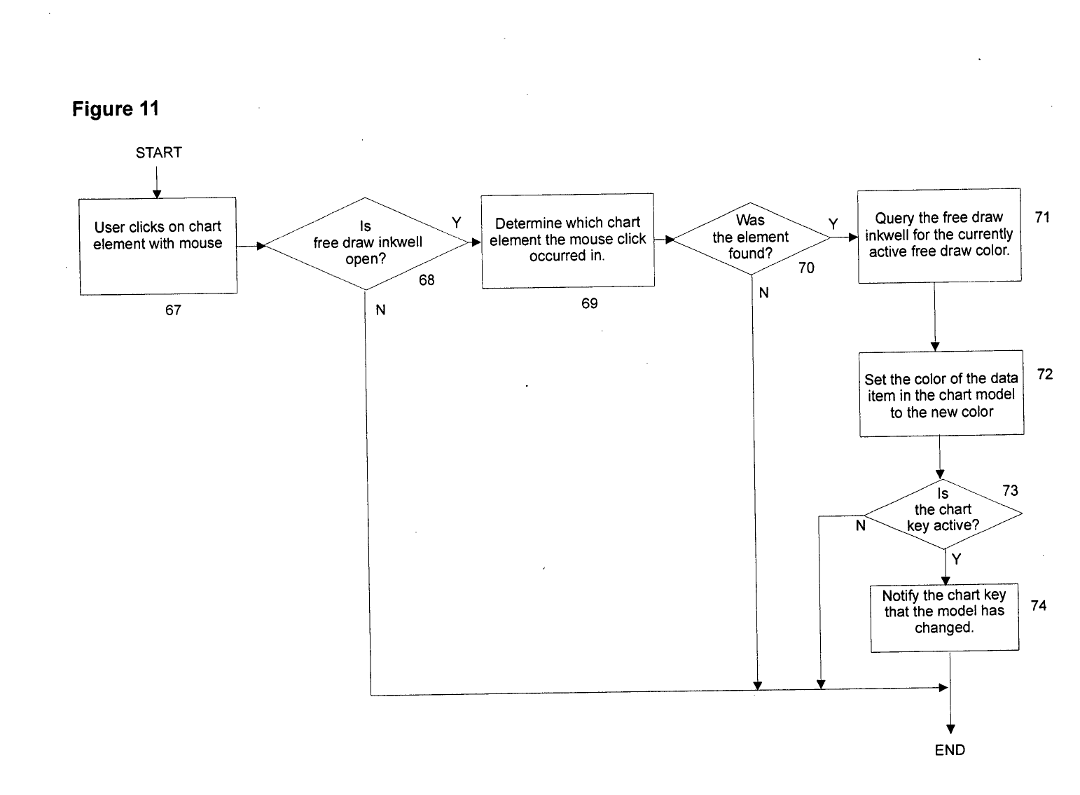

Turning now to FIG. 11, a flowchart of a process for changing the color of a chart element is shown. This process illustrates what happens in the computer program when a user changes the color of a chart element. At the first step 67, a user clicks on a chart element with a mouse. This means that the mouse click occurs within a region of a pie chart, or within one of the bars of a bar chart. Next, at step 68, a determination is made whether the free draw inkwell is open. In the Blackspace operating environment, the free draw inkwell is opened from the main global drawing surface menu (e.g., Info Canvas object). If the free draw inkwell is not open at this time, no further action is taken and the process comes to an end. If the free draw inkwell is open, then the color of the data element (pie segment or bar) will be set to the currently selected color from the free draw inkwell. Thus, if the free draw inkwell is open, then the chart element in which the mouse click occurred is determined, at step 69.

Pie charts and bar charts represent the data from the chart model in different ways. Pie charts display the data as pie segments (a percentage of 360 degrees) and bar charts show the data as a series of rectangles. As an example, for a pie chart, the angle from the center of the pie chart to the coordinates of the mouse click position is calculated. From this angle, the computer program is able to determine in which pie chart segment the click occurred. For a bar chart or graph, the coordinates of the mouse click are compared with the areas covered by each rectangular bar of the bar chart. If the rectangle contains the mouse coordinates, the computer program knows that the user clicked on that particular bar.

Referring to FIG. 5, if a user selects a color in an inkwell, e.g., a free draw inkwell that can support 24 bit color which provides for approximately 16 million separate colors, this color can be used to change the color of any pie chart segment in a pie chart or bar in a bar chart. As an example, the color of a pie chart segment can be changed by first selecting a color in the inkwell and then touching the pie chart segment, the color rectangle that matches the pie chart segment in the chart key for this pie chart, or the text label for the fader controlling the pie chart segment. In all of these cases, changing the color of any one of these variables will change the color of the other two.

Referring back to the flowchart of FIG. 11, at step 70, a determination is made whether the chart element was found. This is a safety check, as the mouse click event would not have reached this stage if it did not lie within the valid clickable region(s) of the chart. If the chart element was not found, then the process comes to an end. If the chart element was found, then the free draw inkwell is queried for the currently active free draw color, at step 71. In this step, the computer program determines what the RGB or CMYK values are for the currently selected color in this inkwell.

Next, at step 72, the color of the data item in the chart model is set to the new color. The chart model is updated to store the new color for the selected chart element, and the chart is redrawn to show the new color. The chart model knows which fader is associated with the selected element, and sets the color of the fader label to the new color. When this happens, the fader emits a signal notifying any charts, which the fader is currently controlling, that the label color for that fader has been changed. Each chart that receives this signal will then modify the chart model of that chart with the new color and redraw itself. This allows a data color change from one chart to be automatically propagated to all other charts that share the same value fader. See the section under the heading “Multiple charts can be controlled by one or more faders or equivalent devices” for more details on faders controlling multiple charts.

Next, at step 73, a determination is made whether the chart key is active. The chart key shares the same chart model data as the chart control. If the chart key is visible onscreen, the chart key is notified that the chart data has changed and must also be redrawn (updated) to show the new chart element color. If the chart key is not active, then the process comes to an end. If the chart key is active, then the chart key is notified that the model has changed, at step 74. The process then comes to an end.

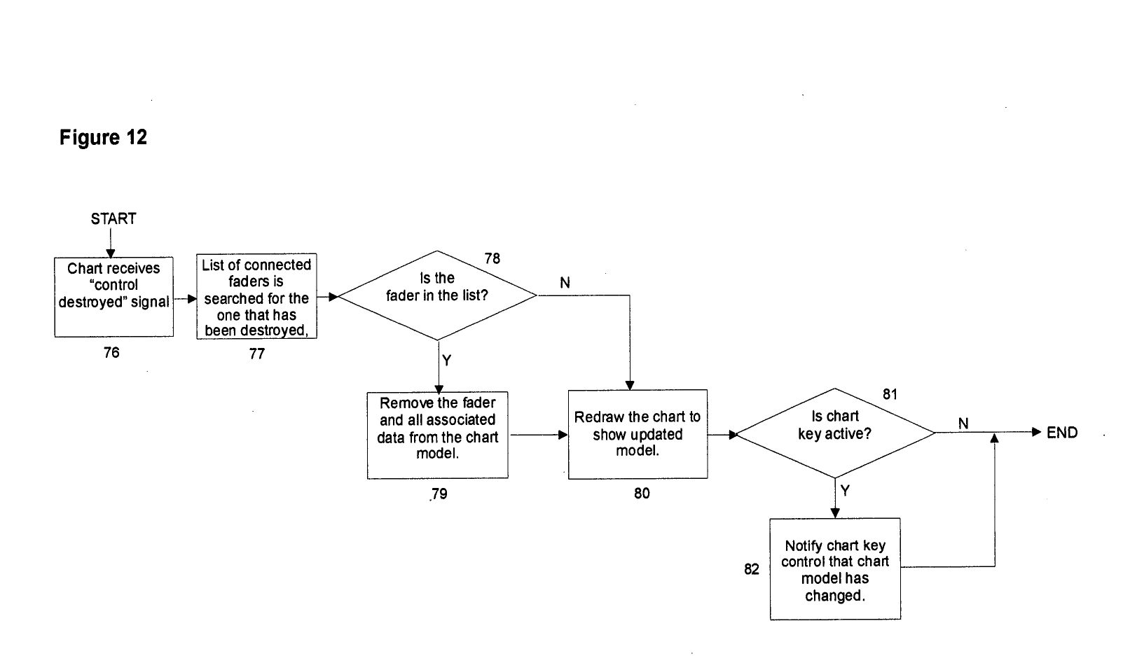

Turning now to FIG. 12, a flowchart of a process for deleting a device that is controlling an element in a graphic chart, such as a pie chart or bar chart, is shown. If a fader that has been added to a chart (see chart creation flowchart of FIG. 8) is deleted, the chart control will automatically receive a “control destroyed” signal. In other words, the chart control will be notified that the fader has been deleted and the internal chart model of the chart will be updated appropriately. The data item in the chart model that was associated with the deleted fader will be removed and the chart will be redrawn to show the changes that have been made to the chart model.

This causes the chart to remove all data associated with that fader from the chart model and redraw itself to show the updated data set. In the case of a pie chart, if all the faders or their equivalents are deleted, the chart will be rendered as a circular outline filled with a red crosshatch pattern. In the case of a bar chart, it will be rendered as an empty chart having X/Y axes but having no bars.

The flowchart of FIG. 12 starts with the step 76, where the chart receives “control destroyed” signal. This signal is received after a fader that controls an element of a chart (e.g., a pie segment or a bar) is deleted. Next, at step 77, a list of connected faders is searched for the one that has been destroyed. In this step, the list of all devices that are currently controlling elements in the chart are searched through to see which one is missing. Next, at step 78, a determination is made whether the fader is in the list. This is a safety check to see if the deleted fader is in the list, although the fader should always be in the list. The fader is removed from the list after the computer program looks at the list. The computer program searches the list to find out the position of the fader in the list. Once the fader has been found in the list, the fader is deleted from the list.

If the fader is not in the list, then the process proceeds to step 80. If the fader is in the list, then the fader and all associated data are removed from the chart model, at step 79. The data in the model consists of the fader itself, and the name, value and color of the data item represented on the chart for that fader. Next, at step 80, the chart is redrawn to show the updated model. That is, the chart is updated to show the deleted fader. This generally results in the chart element being controlled by that fader being removed from the chart.

Next, at step 81, a determination is made whether the chart key is active. In other words, is the chart key visible onscreen? The chart key and the chart both share the same chart model. If the chart key is not active, then the process comes to an end. If the chart key is active, then the chart key control is notified that the chart model has changed, at step 82. In this step, the chart key is updated to show the deletion of the fader and the chart element that it controlled, e.g., a pie chart segment or a bar in a bar chart. The process then comes to an end.

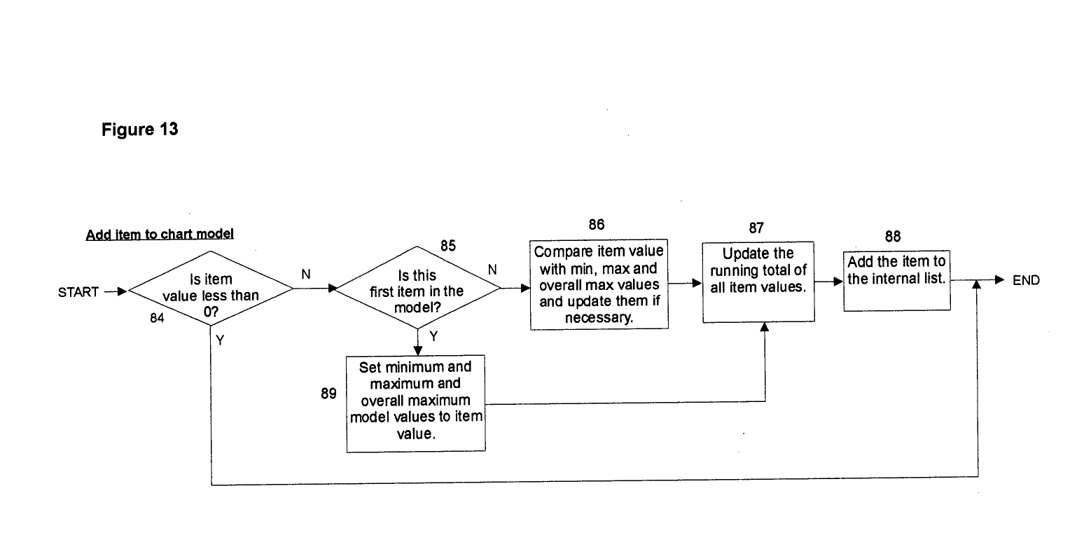

Turning now to FIG. 13, a flowchart of a process for adding an item to the chart model is shown, illustrating how the computer software keeps track of the data that is currently being displayed. A chart model is used by pie charts and bar charts to store the data items currently being visualized by the chart control. The chart model is a C++ class used by the computer program to manage the list of data items currently being displayed.

The chart model maintains a list containing the following information for each pie chart segment of a pie chart or a bar of a bar chart:
1) The name.
2) The color.
3) The value.
4) A pointer to the graphic control (e.g. a value fader) that the user manipulates to alter the chart data item.

The name, value or color of any item may be retrieved or changed. The chart model also keeps track of the number of items it contains and the sum of all their values. The value of any item may be retrieved as a percentage of the total (this feature is used by pie charts). The current minimum and maximum values of all items are also maintained and may be retrieved.

If a chart data item is added, deleted or has its value changed (due to a value fader being added to the chart, removed from the chart or being manipulated to change the numeric value), the current total, minimum and maximum are recalculated. The model maintains a variable, which stores the overall maximum value that any of the data items has been set to so far. Note: the terms “item” and “data item” are synonymous for the purposes of this specification.

For example, if all items have the value “10”, and then one is given the value “100”, the current maximum and overall maximum will be set to “100”. If that item is then returned to the value “10”, the current maximum will also return to “10” but the overall maximum will remain at “100” (until it is exceeded once again). Thus, the “current maximum” is the maximum value of all the data items in the chart model. For example, a user creates a chart with three faders. The value of the first fader (what that fader is set to) is “10”, the value of the second fader is “20” and the value of the third fader is “30”. The current maximum for the chart model controlled by these three faders is “30”. The overall maximum of this chart model is “30”. The overall maximum is the highest value that the current maximum has ever been set to. Continuing the discussion of the overall maximum and current maximum, if the third fader of this example was increased to “100”, then the overall maximum and the current maximum would both equal 100. If however, the value of this fader was lowered to “30” again, then the overall maximum would equal “100” and the current maximum would become “30”.

Continuing with this example, if the second fader was increased to a value of “40”, then the new current maximum for the chart model would become “40”. However, the overall maximum would remain at “100”. The current minimum for chart model of this example would be “10”, as this is the setting of the lowest value fader. The current minimum equals the lowest set value of any device (in this case a fader) that is used to control a chart model.

If the three faders in the above example are used to create a bar chart, the overall maximum is the highest value ever reached by any of the data items during the existence of the chart model. If one of the fader values is increased to equal “100”, then the overall size of the bar chart is increased to accommodate this longer bar. If then the fader controlling this bar has its value lowered to, e.g., “35”, then the bar is decreased in size, but the overall size of the bar chart remains the larger size as the overall maximum for that bar chart has been increased to “100”. The overall maximum is used to set the overall size of a bar chart but it does not affect the overall size of a pie chart. As an alternative, when the maximum fader just described above is lowered to a value of “35”, the overall size of the bar chart can similarly be reduced, either by the total value change (in this case the difference between “100” and “35”, or by some percentage of that change.

The current total for all devices, e.g., faders, that are controlling a pie chart is used in determining the individual sizes of each pie segment. Each fader is represented as a percentage of the current total. This percentage is represented as a certain size of a pie segment in the pie chart.

In summary, pie charts make use the total value of all the faders that are controlling the pie chart when calculating what percentage of the total value as represented by each pie segment. Bar charts, on the other hand, utilize each fader value to set the length or height of each individual bar and the overall maximum to calculate the overall size of the entire bar chart. The current maximum is used to determine the overall maximum as the overall maximum is increased if the value of the current maximum exceeds the value of the overall maximum at any point in time. The overall maximum is used by bar charts to allow their range to be adjusted to the maximum value that was ever used by any given set of data.

Referring to the flowchart of FIG. 13, at step 84, a determination is made whether the item value is less than “0”. A pie chart generally does not display values that are less than zero, but a bar graph can. This step in the flowchart of FIG. 13 is optional. If this step is used, then one approach would be that the pie chart model only accepts values greater than or equal to zero, but that bar charts may contain negative values. Assuming that the chart model only accepts values greater than or equal to zero, if the item value is less than “0”, then the process comes to an end. If the item value is not less than “0”, then a determination is made whether this item is the first item in the chart model, at step 85. As chart data items are added to the chart model, the current minimum, current maximum and overall maximum values are compared with the value of that data item and changed if necessary. For example, if the value is less than the current minimum, the current minimum is set to the value of that data item. If the data item is the first to be added to the chart model, the current minimum, current maximum and overall maximum are simply set to the value of that item as that value is the only value in the chart model. At that point, the current minimum, current maximum and overall maximum are all the same.

If the item is the first item, then minimum, maximum and overall maximum model values are set to the item value, at step 89, and the process proceeds to step 87. The item to be used to create a chart determines the current minimum and current maximum for that chart model. If the item is not the first item, then the item value is compared with the minimum, maximum and overall maximum values and the values are updated if necessary, at step 85. When a subsequent item is added to the chart model, the value of that item is compared with the current minimum, current maximum and overall maximum in the model and these variables are changed as needed.

Next, at step 87, the running total of all item values is updated. This running total is the sum of all values represented by all of the devices that are currently controlling the chart model. These devices may be faders, knobs, joysticks or the like. As new devices are added to a chart model, the new values represented by these added devices are used to increase the total value of the chart model. In other words, the running total is the sum of all the values of all the devices currently controlling that chart model.

Next, at step 88, the item is added to the internal list. The chart data items are stored within the chart model in a C++ structure called a list, which allows addition, deletion and retrieval of chart data items. The process then comes to an end.

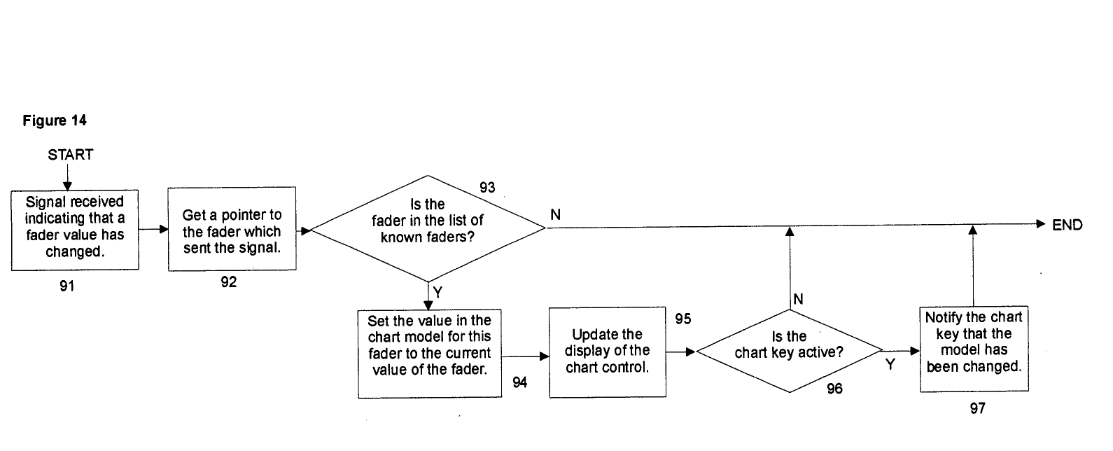

Turning now to FIG. 14, a flowchart of a process for responding to a change in a fader value is shown, illustrating what happens when a user changes the value of a fader that is connected to one of the pie chart segments or bars in a bar chart. Faders are connected to pie charts and bar charts (“charts”) by means of a signaling mechanism. Such signaling mechanism serves the purpose of allowing a first object to notify a second object of a change in the value of the first object.

When the value of a fader is changed, the fader emits a signal that notifies the chart(s), which the fader is connected to, that the value has changed. When this happens, the chart must update the chart model with the new value, and redraw the chart and chart key (if active) with the new value. This process is the same for both pie and bar charts.

The process starts from step 91, where a signal is received that a fader value has changed. When a fader is added to a chart, the “value changed” signal is connected to the chart via the signaling mechanism as defined above. When the value of the fader is changed, the chart automatically receives notification of this event and can respond appropriately. In this case, the chart can respond by getting the new value of the fader and updating the chart model and display (the displayed chart) as necessary. Next, at step 92, a pointer to the fader which sent the signal is retrieved. The signaling mechanism provides information regarding the object that sent the signal. This provides a “sender” function that provides the code with a pointer to the object that sent the signal currently being handled. This pointer allows the computer program to determine which fader sent the signal. The pointer is the address in memory that equals the fader that sent the signal. In this case, what is provided is a pointer to a value fader.

Next, at step 93, a determination is made whether the fader is in the list of known faders. When faders are added to the chart, the chart maintains a list of those faders. When a fader is disconnected from the chart (e.g. by being deleted), the fader is removed from that list. This test is just a precaution, since the fader should always be in the list of faders for the chart.

If the fader is not in the list, then the process comes to an end. If the fader is in the list, the value in the chart model for this fader is set to the current value of the fader, at step 94. The current value of the fader is acquired from the fader object, and the chart model is updated with the new value for that fader. Next, at step 95, the display of the chart control is updated. The pie chart or bar graph display is changed to reflect the change in the value of the fader.

Next, at step 96, a determination is made whether the chart key is active. The chart key may not have been created at this point, as it is optional. Note: on the Info Canvas object for a pie chart or bar chart is the option “Chart Key”. When the “Chart Key” option is selected, the key is built and then it becomes visible onscreen.

If the chart key has been created, the chart key needs to be notified that the chart model has changed. If the chart key is not active, then the process comes to an end. If the chart key is active, then the chart key is notified that the chart model has been changed, at step 97. The chart key is notified of the change, and must update its internal variables accordingly to ensure that the values the chart key displays are correct. Then the process comes to an end.

Multiple charts can be controlled by one or more faders or equivalent devices. Each value fader used for the manipulation of pie charts and bar charts may be connected to any number of chart controls. The faders can be linked (using arrows—in the case of the examples above, red arrows representing a “control logic”) to an arbitrary number of different controls. This means that one fader may be used to control a data item (pie segment or bar chart bar) on more than one chart at a time. Also, a fader may be linked to different types of charts. For example, a single fader could be connected to two pie charts and three bar charts at once. When the fader is manipulated, all five charts would be updated at once along with their keys.

From the perspective of the individual chart, the chart is simply receiving a normal “value changed” signal in the standard manner and acts accordingly. Each chart control has no knowledge of any other charts, or what else a fader may be linked to. One feature of the way that charts and faders are connected is the way colors may be propagated from one chart to another, via the fader. (See flowchart of FIG. 9 for details of the way fader colors are assigned.) If the user changes the color of a data item (a segment of a pie chart or a bar of a bar chart), the new color is stored in the chart data model. The chart model sets the color of the label on the fader associated with that data item to the new color. When the fader label color is changed, the fader emits a signal notifying any attached controls (one or more charts in this case) that the label has been altered. Each attached chart then queries the fader for the new color and sets the color of the associated data item to the new color. Therefore, if one fader is attached to two or more different charts, changing the color of the data item in one chart will cause the color of all other data items associated with that fader (on the other charts) to be set to the same color. See the flowchart of FIG. 11 for details of this process.

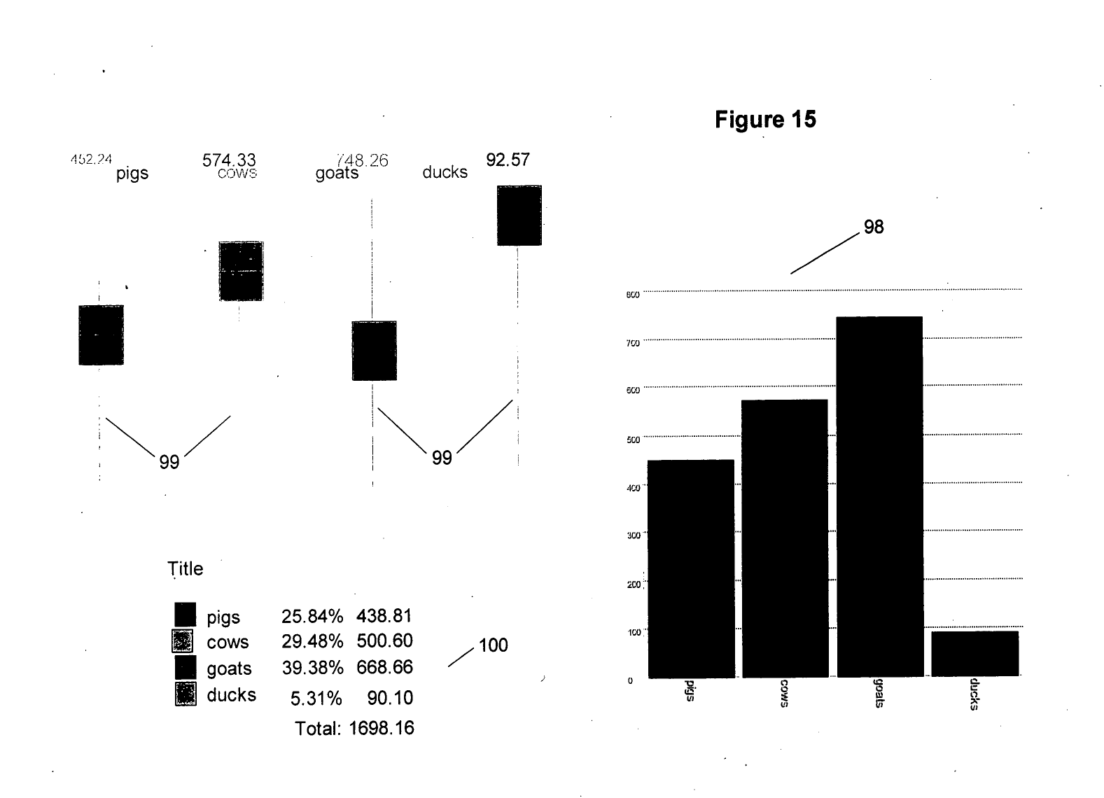

Turning now to FIG. 15, a vertical bar chart 98 that has been created using a method in accordance with the invention shown. The vertical bar chart 98 includes four vertical bars labeled “pigs”, “cows”, “goats” and “ducks”. These vertical bars are individually controlled by faders 99, which are labeled to correspond to the vertical bars of the bar chart 98. A bar chart key 100 is also shown in FIG. 15. The bar chart key 100 is virtually identical to a pie chart key, such as the pie chart key 18 shown in FIG. 4. The bar chart key 100 consists of multiple rows and columns. Each row corresponds to a bar of the bar chart 98. One of the columns contains colored rectangles that match the colors of the bars of the bar chart 98. Another column includes the title of each bar, e.g., pigs, cows, goats and ducks. Another column includes the relative percentages of the bars with respect to the sum of values for all the bars of the bar chart 98. Finally, the last column includes the numeric values of the bars in the bar chart 98 that equal the numeric settings of the faders 99. Thus, for each bar or category, the color of the corresponding bar in the bar chart 98, the corresponding label, the corresponding relative percentage and the corresponding numeric value can be readily determined by the chart key 100.

The bar chart 98 can be created by a user in a similar manner as a pie chart, such as the pie chart 16 shown in FIG. 3. The faders 99 are first created and programmed by, for example, dragging groups of numeric and/or textual characters to intersect any part of the faders or fall within a gap distance to the faders. The textual characters are used to label the faders 99. The numeric characters are used to set the numeric value, scaling resolution, the range (minimum and maximum values), position of the fader cap of the faders 99. The user then draws a “control” arrow that selectively intersects or encircles the faders 99 to be used to create the bar chart 98. The control arrow is then modified using a modifier arrow that intersects the shaft of the control arrow. Thus, the arrow logic associated with the control arrow is modified by the modifier arrow. Once the modified arrow logic is recognized, a text cursor appears at the tip of the modifier arrow so that the user can enter the desired type of graphic chart to be created. In this instance, the desired graphic chart is a bar chart. Thus, the user enters “bar chart” and activates the modified arrow logic by, for example, touching one of the arrowheads. The bar chart 98 is then created using the parameters of the faders 99.

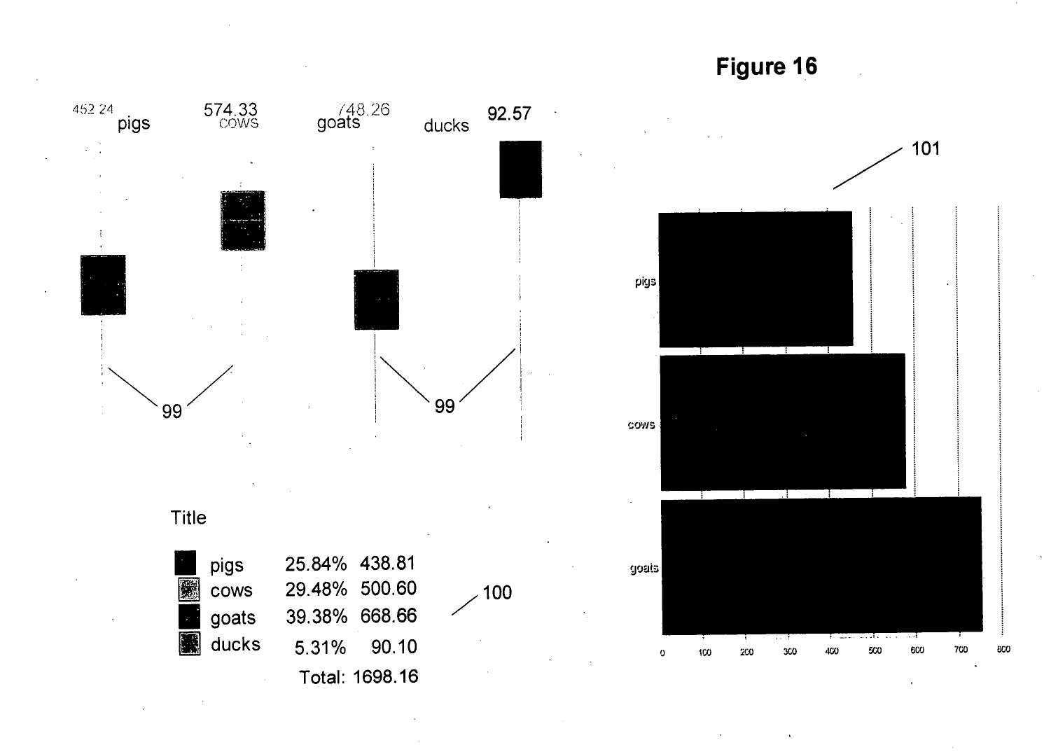

As shown in FIG. 16, the vertical bar chart 98 can be converted into a horizontal bar chart 101 by selecting an appropriate entry in a menu. For example, the entry “horizontal” may be selected in an Info Canvas object for the bar chart 98. The horizontal bar chart 101 can be then converted back to the vertical bar chart 98 by selecting another appropriate entry in a menu. For example, the entry “vertical” may be selected in the Info Canvas object for the bar chart 101.

The process for manipulating a vertical or horizontal bar chart is virtually identical to the manipulation process of a pie chart. The numeric value of any bar in a bar chart can be changed using an associated fader. In addition any common aspect between a corresponding fader, a bar chart key and a bar chart can be collectively changed by changing that aspect in one of the three objects. A new bar can be added to a bar chart in the same manner as adding a new pie segment to a pie chart. An existing bar can be deleted from a bar chart in the same manner as deleting an existing pie segment from a pie chart. Further more, a single fader can be used to control bars in different bar charts in the same manner as for pie chart. In fact, a single fader can be used to control both a bar in a bar chart and a pie segment in a pie chart.

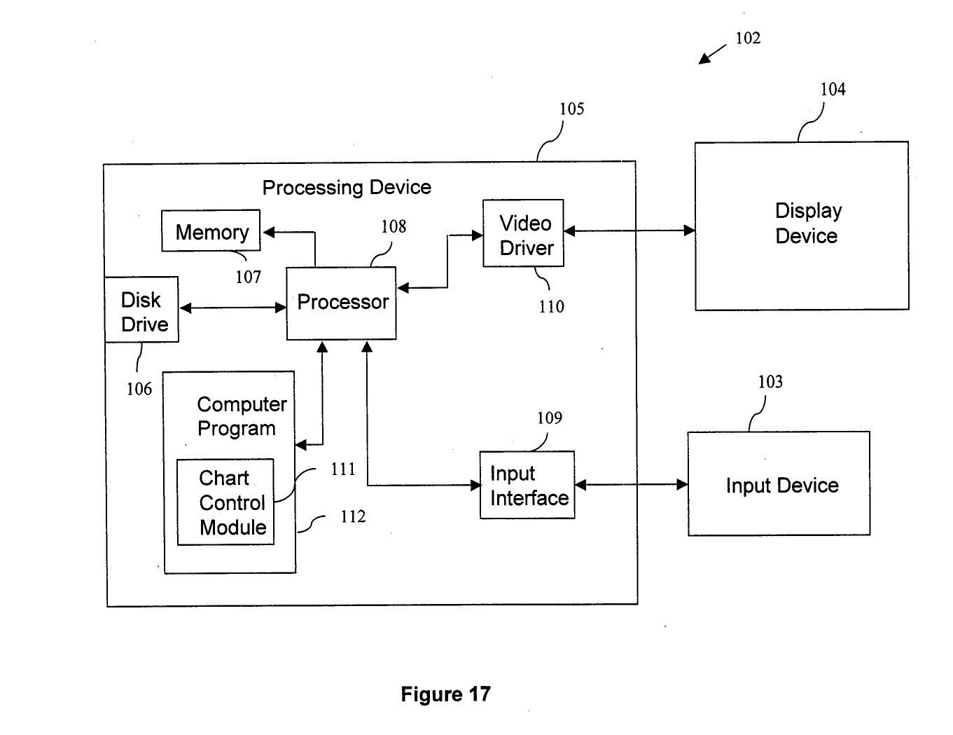

Turning now to FIG. 17, a computer system 102 in which the method for creating and manipulating graphic charts in accordance with an embodiment of the invention has been implemented is shown. The computer system 102 may be a personal computer, a personal digital assistant (PDA) or any computing system with a display device. In one embodiment, the method may be embodied in a computer readable storage medium, such as a CD, that includes instructions, which can be executed by the computer system 102, to implement the method in the system.

As illustrated in FIG. 17, the computer system 102 includes an input device 103, a display device 104 and a processing device 105. Although these devices are shown as separate devices, two or more of these devices may be integrated together. The input device 103 allows a user to input commands into the system 102 to, for example, change the values of faders to modify pie and/or bar charts. In one embodiment, the input device 103 includes a computer keyboard and a mouse. However, the input device 104 may be any type of electronic input device, such as buttons, dials, levers and/or switches on the processing device 105. Alternative, the input device 103 may be part of the display device 104 as a touch-sensitive display that allows a user to input commands using a stylus. The display device 104 may be any type of a display device, such as those commonly found in personal computer systems, e.g., CRT monitors or LCD monitors.

The processing device 106 of the computer system 102 includes a disk drive 106, memory 107, a processor 108, an input interface 109, and a video driver 110. The processing device 106 further includes a chart control module 111, which performs various steps of the method. As shown in FIG. 17, the chart control module 111 may be implemented as part of a computer program 112, e.g., a Blackspace program that provides the Blackspace operating environment. In this embodiment, the chart control module 111 is implemented as software. However, the chart control module 111 may be implemented in any combination of hardware, firmware and/or software.

The disk drive 106, the memory 107, the processor 108, the input interface 109 and the video driver 1 10 are components that are commonly found in personal computers. The disk drive 106 provides a means to input data and to install programs into the system 102 from an external computer readable storage medium. As an example, the disk drive 106 may a CD drive to read data contained therein. The memory 107 is a storage medium to store various data utilized by the computer system 102. The memory 107 may be a hard disk drive, read-only memory (ROM) or other forms of memory. The processor 108 may be any type of digital signal processor that can run the computer program 112, including the chart control module 111. The input interface 109 provides an interface between the processing device 105 and the input device 103. The video driver 110 drives the display device 104. In order to simplify the figure, additional components that are commonly found in a processing device of a personal computer system are not shown or described.

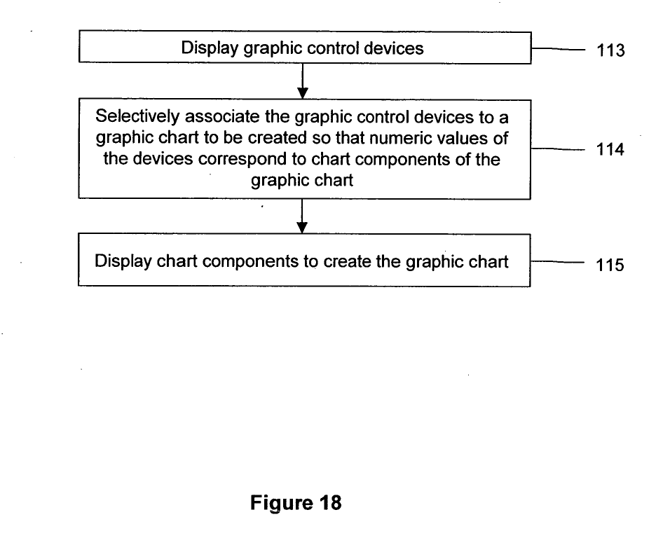

A method for creating and manipulating graphic charts, e.g., pie and bar charts, in accordance with an embodiment of the invention is described with reference to a flow diagram of FIG. 18. At step 113, graphic control devices that are controllable by a user to change numeric values of the devices are displayed. These graphic control devices can be any devices having a numeric setting that can be changed, such as faders, dials, knobs, levers, switches, joysticks and buttons. At step 114, the graphic control devices are selectively associated to a graphic chart to be created so that the numeric values of the graphic control devices correspond to chart components of the graphic chart, e.g., pie segments of a pie chart or bars of a bar chart. At step 115, the chart components are displayed to create the graphic chart. The displayed chart components visually represent the numeric values of the graphic control devices.

Although specific embodiments of the invention have been described and illustrated, the invention is not to be limited to the specific forms or arrangements of parts so described and illustrated. The scope of the invention is to be defined by the claims appended hereto and their equivalents.

1. A method for creating and manipulating graphic charts, said method comprising:
displaying graphic control devices that are controllable by a user to change numeric values of said graphic control devices;
selectively associating said graphic control devices to a graphic chart to be created so that said numeric values of said graphic control devices correspond to chart components of said graphic chart; and
displaying said chart components to create said graphic chart, said chart components visually representing said numeric values of said graphic control devices.

2. The method of claim 1 further comprising:
changing a numeric value of a selected graphic control device of said graphic control device; and
changing the size of one of said chart components that corresponds to said selected graphic control device to reflect said changing of said numeric value.

3. The method of claim 1 further comprising:
deleting a selected graphic control device of said graphic control devices; and
removing a chart component that corresponds to said selected graphic control device from said graphic chart.

4. The method of claim 1 further comprising:
associating an additional graphic control device having a numeric value to said graphic chart; and
inserting an additional chart component into said graphic chart in response to said associating of said additional graphic control device, said additional chart component corresponding to said additional graphic control device such that said numeric value of said additional graphic control device is visually represented by said additional chart component.

5. The method of claim 1 wherein said displaying of said graphic control devices includes programming said graphic control devices with at least one of text and numeric value.

6. The method of claim 1 further comprising displaying a chart key that corresponds to said graphic chart, said chart key including informational data associated with said chart components of said graphic chart.

7. The method of claim 6 wherein said informational data associated with said chart components included in said chart key comprises one of label, color, relative percentage, and a numeric value

8. The method of claim 6 further comprising:
changing an element of said informational data; and
changing related elements in said graphic control devices and said graphic chart in response to said changing of said element of said informational data.

9. The method of claim 6 further comprising:
changing a numeric value of a selected graphic control device of said graphic control device;
changing the size of one of said chart components that corresponds to said selected graphic control device in response to said changing of said numeric value; and
changing said information data included in said chart key to reflect said changing of said numeric value.

10. The method of claim 1 further comprising:
associating an additional graphic control device having a numeric value to said graphic chart and a second graphic chart; and
inserting a first additional chart component into said graphic chart and a second additional chart component into said second graphic chart in response to said associating of said additional graphic control device, said first and second additional chart components corresponding to said additional graphic control device such that said numeric value of said additional graphic control device is visually represented by said first and second additional chart components.

11. The method of claim 10 further comprising:
charging said numeric value of said additional graphic control device; and
changing the size of said first and second additional chart components to reflect said changing of said numeric value.

12. The method of claim 10 further comprising displaying a first chart key that corresponds to said graphic chart and a second chart key that corresponds to said second graphic chart, said first chart key including first informational data associated with chart components of said graphic chart, said second chart key including second informational data associated with chart components of said second graphic chart.

13. The method of claim 12 further comprising:
changing an element of said first informational data associated with said additional graphic control device; and
changing related elements in said additional graphic control device, said graphic chart, said second graphic chart, and said second information data in response to said changing of said element of said first informational data.

14. A storage medium readable by a computer, tangibly embodying a program of instructions executable by said computer to perform method steps for creating and manipulating graphic charts, said method steps comprising:
displaying graphic control devices that are controllable by a user to change numeric values of said graphic control devices;
selectively associating said graphic control devices to a graphic chart to be created so that said numeric values of said graphic control devices correspond to chart components of said graphic chart; and
displaying said chart components to create said graphic chart, said chart components visually representing said numeric values of said graphic control devices.

15. The storage medium of claim 14 further comprising:
changing a numeric value of a selected graphic control device of said graphic control device; and
changing the size of one of said chart components that corresponds to said selected graphic control device to reflect said changing of said numeric value.

16. The storage medium of claim 14 further comprising:
deleting a selected graphic control device of said graphic control devices; and
removing a chart component that corresponds to said selected graphic control device from said graphic chart.

17. The storage medium of claim 14 further comprising:
associating an additional graphic control device having a numeric value to said graphic chart; and
inserting an additional chart component into said graphic chart in response to said associating of said additional graphic control device, said additional chart component corresponding to said additional graphic control device such that said numeric value of said additional graphic control device is visually represented by said additional chart component.

18. The storage medium of claim 14 wherein said displaying of said graphic control devices includes programming said graphic control devices with at least one of text and numeric value.

19. The storage medium of claim 14 further comprising displaying a chart key that corresponds to said graphic chart, said chart key including informational data associated with said chart components of said graphic chart.

20. The storage medium of claim 19 wherein said informational data associated with said chart components included in said chart key comprises one of label, color, relative percentage, and a numeric value

21. The storage medium of claim 19 further comprising:
changing an element of said informational data; and
changing related elements in said graphic control devices and said graphic chart in response to said changing of said element of said informational data.

22. The storage medium of claim 19 further comprising:
changing a numeric value of a selected graphic control device of said graphic control device;
changing the size of one of said chart components that corresponds to said selected graphic control device in response to said changing of said numeric value; and
changing said information data included in said chart key to reflect said changing of said numeric value.

23. The storage medium of claim 14 further comprising:
associating an additional graphic control device having a numeric value to said graphic chart and a second graphic chart; and
inserting a first additional chart component into said graphic chart and a second additional chart component into said second graphic chart in response to said associating of said additional graphic control device, said first and second additional chart components corresponding to said additional graphic control device such that said numeric value of said additional graphic control device is visually represented by said first and second additional chart components.

24. The storage medium of claim 23 further comprising:
changing said numeric value of said additional graphic control device; and
changing the size of said first and second additional chart components to reflect said changing of said numeric value.

25. The storage medium of claim 23 further comprising displaying a first chart key that corresponds to said graphic chart and a second chart key that corresponds to said second graphic chart, said first chart key including first informational data associated with chart components of said graphic chart, said second chart key including second informational data associated with chart components of said second graphic chart.

26. The storage medium of claim 25 further comprising:
changing an element of said first informational data associated with said additional graphic control device; and
changing related elements in said additional graphic control device, said graphic chart, said second graphic chart, and said second information data in response to said changing of said element of said first informational data.
